(19) United States
(12) Patent Application Publication
(10) Pub. No.: US 2023/0347925 A1
(43) Pub. Date: Nov. 2, 2023

(54) AGENT AND SCENARIO MODELING EXTRACTED VIA AN MBSE CLASSIFICATION ON A LARGE NUMBER OF REAL-WORLD DATA SAMPLES

(71) Applicant: TOYOTA RESEARCH INSTITUTE, INC., Los Altos, CA (US)

(72) Inventors: Daniel STONIER, Cambridge, MA (US); Sachit VITHALDAS, Mountain View, MA (US); Chien-Liang FOK, Belmont, MA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 17/733,901

(22) Filed: Apr. 29, 2022

(51) Int. Cl. B60W 60/00; B60W 40/09; G06K 9/62

(52) U.S. Cl. CPC B60W 60/001; B60W 40/09; G06K 9/6256; B60W 2420/42

(57) ABSTRACT

A method for agent and scenario modeling is described. The method includes analyzing, through a model-based systems engineering (MBSE) model, high-level events extracted from driving log data to identify a dataset of interest from the driving log data. The method also includes extracting an episode of interest from the dataset of interest according to an MBSE state transition diagram. The method further includes generating a driving scenario of interest based on the episode of interest. The method also includes utilizing the driving scenario of interest to parameterize agent and/or scenario models used for autonomous operation of an ego vehicle.

### BACKGROUND

### Field

Certain aspects of the present disclosure generally relate to machine learning and, more particularly, agent and scenario modeling extracted via a model-based systems engineering (MBSE) classification on a large number of real-world data samples.

### Background

Autonomous agents, such as self-driving cars and robots, are quickly evolving and are now a reality in this decade. Self-driving cars rely on various ways of perceiving an environment. Unfortunately, the various ways used by self-driving cars to perceive a surrounding environment are not entirely reliable. In addition, because self-driving cars have to interact with other vehicles, such as cars, trucks, buses, motorcycles, bicycles, and pedestrians, many critical safety concerns arise. For example, one critical concern is how to design vehicle control of an autonomous vehicle using machine learning.

Unfortunately, vehicle control by machine learning may be ineffective in situations involving complex interactions between vehicles (e.g., a situation where an ego vehicle changes from one traffic lane into another traffic lane). Machine learning techniques for vehicle control by selecting an appropriate vehicle control action of an ego vehicle are desired. For example, a selected speed/acceleration/steering angle of an ego vehicle may be applied as a vehicle control action. Autonomous vehicles as well as vehicles operated by expert drivers generate a log of data during real-world driving scenarios. These techniques generate large datasets regarding various different driving scenarios. Unfortunately, because of the size and difficulty of parsing through these large datasets, the detection and extraction of episodes of interest can be difficult and time-consuming.

### SUMMARY

A method for agent and scenario modeling is described. The method includes analyzing, through a model-based systems engineering (MBSE) model, high-level events extracted from driving log data to identify a dataset of interest from the driving log data. The method also includes extracting an episode of interest from the dataset of interest according to an MBSE state transition diagram. The method further includes generating a driving scenario of interest based on the episode of interest. The method also includes utilizing the driving scenario of interest to parameterize agent and/or scenario models used for autonomous operation of an ego vehicle.

A non-transitory computer-readable medium having program code recorded thereon for agent and scenario modeling is described. The program code is executed by a processor. The non-transitory computer-readable medium includes program code to analyze, through a model-based systems engineering (MBSE) model, high-level events extracted from driving log data to identify a dataset of interest from the driving log data. The non-transitory computer-readable medium also includes program code to extract an episode of interest from the dataset of interest according to an MBSE state transition diagraph. The non-transitory computer-readable medium further includes program code to generate a driving scenario of interest based on the episode of interest. The non-transitory computer-readable medium also includes program code to utilize the driving scenario of interest to parameterize agent and/or scenario models used for autonomous operation of an ego vehicle.

A system for agent and scenario modeling is described. The system includes a model-based systems engineering (MBSE) model to analyze high-level events extracted from driving log data to identify a dataset of interest from the driving log data. The system also includes an episode extraction module to extract an episode of interest from the dataset of interest according to an MBSE state transition diagraph. The system further includes a scenario generation module to generate a driving scenario of interest based on the episode of interest. The system also includes an agent and scenario modeling to utilize the driving scenario of interest to parameterize agent and/or scenario models used for autonomous operation of an ego vehicle.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for agent and scenario modeling, in accordance with aspects of the present disclosure.

FIG. 2 is a block diagram illustrating a software architecture that may modularize functions for agent and scenario modeling, according to aspects of the present disclosure.

FIG. 3 is a diagram illustrating an example of a hardware implementation for an agent and scenario modeling system, according to aspects of the present disclosure.

FIG. 4 is a block diagram of a vehicle training and model verification system 400 for the agent and scenario modeling system of FIG. 3, in accordance with an illustrative configuration of the present disclosure.

FIG. 5 is a diagram illustrating an overview of a traffic environment, including vehicles on highway lanes as well as an ego vehicle prior to a lane change, according to aspects of the present disclosure.

FIG. 6 illustrates a model-based systems engineering (MBSE) state transition diagram for defining a vehicle's behavior during a lane change, according to aspects of the present disclosure.

FIG. 7 is a flowchart illustrating a method for agent and scenario modeling, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality, in addition to or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents, such as self-driving cars and robots, are quickly evolving and are now a reality in this decade. Self-driving cars rely on various ways of perceiving an environment. Unfortunately, the various ways used by self-driving cars to perceive a surrounding environment are not entirely reliable. In addition, because self-driving cars have to interact with other vehicles, such as cars, trucks, buses, motorcycles, bicycles, and pedestrians, many critical safety concerns arise. For example, one critical concern is how to design vehicle control of an autonomous vehicle using machine learning.

Automation of vehicle control on highways is rapidly advancing and is a reality in this decade. These automated vehicles are expected to reduce traffic accidents and improve traffic efficiency. In particular, improved machine learning techniques for vehicle control that operate by selecting an appropriate vehicle control action of an ego vehicle are desired. For example, a selected speed/acceleration/steering angle of the ego vehicle may be applied as a vehicle control action. Unfortunately, vehicle control by machine learning may be ineffective in situations involving complex interactions between vehicles (e.g., a situation where an ego vehicle changes from one traffic lane into another traffic lane).

In particular, safety is a critical concern when building autonomous agents that operate in human environments. For autonomous driving in particular, safety is a formidable challenge due to high speeds, rich environments, and complex dynamic interactions with many traffic participants, including vulnerable road users. Testing and verification of machine learning techniques for vehicle control by selecting an appropriate vehicle control action of an ego vehicle are desired. For example, autonomous test vehicles as well as test vehicles operated by expert drivers generate a log of data during real-world driving scenarios. These vehicles generate large datasets regarding various different driving scenarios. Unfortunately, because of the size and difficulty of parsing through these large datasets, the detection and extraction of episodes of interest can be difficult and time-consuming.

Aspects of the present disclosure are directed to using a flowchart to identify datasets of interest from large datasets of a log generated by autonomous test vehicles as well as test vehicles operated by expert drivers during real-world driving scenarios. These vehicles generate large datasets regarding various different driving scenarios. Unfortunately, because of the size and difficulty parsing through these large datasets, the detection and extraction of episodes of interest can be difficult and time-consuming. Some aspects of the present disclosure are directed to application of a model-based systems engineering (MBSE) approach to detect and extract episodes of interest from large datasets.

In some aspects of the present disclosure, this MBSE approach breaks down each driving situation into a flowchart that describes a vehicle's behavior in a particular scenario. In an example, a flowchart (e.g., generated via an MBSE approach) in conjunction with a statistical or machine learning model are used to identify datasets of interest (e.g., from amongst a large dataset). For example, in a scenario involving a lane change, the flowchart includes decision trees such as “is the lane next to me vacant/not vacant.” The decision tree continues down each branch related to a lane change. In another example, the MBSE flowchart in conjunction with the machine learning model is used to identify datasets of interest corresponding to vehicles exceeding the speed limit in a locale by 10/20 mph. Such datasets may then be used to parameterize agent and/or scenario models used for testing an autonomous vehicle.

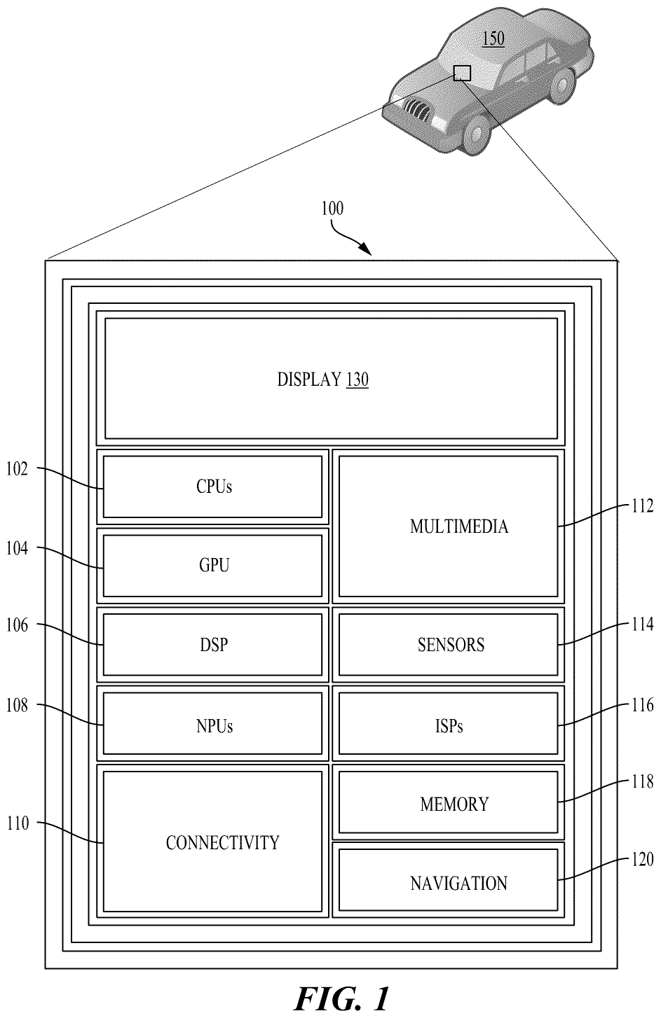

FIG. 1 illustrates an example implementation of the aforementioned system and method for agent and scenario modeling using a system-on-a-chip (SOC) 100 of an ego vehicle 150. The SOC 100 may include a single processor or multi-core processors (e.g., a central processing unit (CPU)), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The system-on-a-chip (SOC) 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of objects in an area of interest, according to the display 130, illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system (GPS).

The system-on-a-chip (SOC) 100 may be based on an Advanced Risk Machine (ARM) instruction set or the like. In another aspect of the present disclosure, the SOC 100 may be a server computer in communication with the ego vehicle 150. In this arrangement, the ego vehicle 150 may include a processor and other features of the SOC 100. In this aspect of the present disclosure, instructions loaded into a processor (e.g., CPU 102) or the NPU 108 of the ego vehicle 150 may include code for agent and scenario modeling from an image captured by the sensor processor 114. The instructions loaded into a processor (e.g., CPU 102) may also include code for planning and control (e.g., of the ego vehicle 150) in response to the agent and scenario modeling from the images captured by the sensor processor 114.

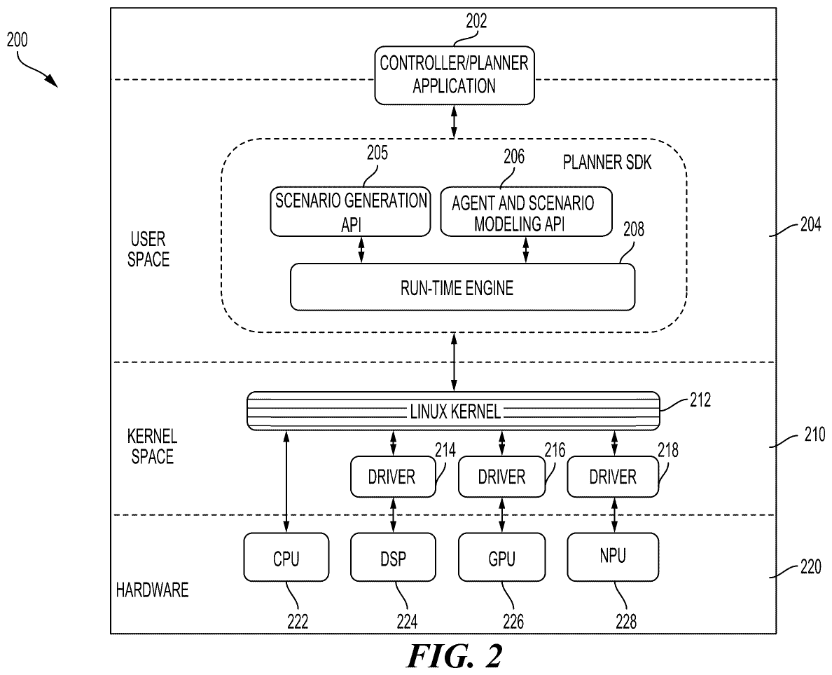

FIG. 2 is a block diagram illustrating a software architecture 200 that may modularize functions for planning and control of an ego vehicle using agent and scenario modeling, according to aspects of the present disclosure. Using the architecture, a controller/planner application 202 may be designed such that it may cause various processing blocks of a system-on-a-chip (SOC) 220 (for example a CPU 222, a DSP 224, a GPU 226, and/or an NPU 228) to perform supporting computations during run-time operation of the controller/planner application 202.

The controller/planner application 202 may be configured to call functions defined in a user space 204 that may, for example, operate an ego vehicle based on agent and scenario modeling used to train the controller/planner application 202. In aspects of the present disclosure, application of a model-based systems engineering (MBSE) approach is applied to detect and extract episodes of interest from large datasets for agent and scenario modeling. The controller/planner application 202 may make a request to compile program code associated with a library defined in a scenario generation application programming interface (API) 205 to generate a driving scenario of interest based on an episode of interest extracted from a dataset of interest according to an MBSE flowchart. The controller/planner application 202 may make a request to compile program code associated with a library defined in an agent and scenario modeling API 206. For example, agent and scenario modeling API 206 utilizes the driving scenario of interest to parameterize agent and/or scenario models used for autonomous operation of an ego vehicle.

A run-time engine 208, which may be compiled code of a run-time framework, may be further accessible to the controller/planner application 202. The controller/planner application 202 may cause the run-time engine 208, for example, to parameterize agent and/or scenario models used for autonomous operation of an ego vehicle using a generated driving scenario of interest. When an object is detected within a predetermined distance of the ego vehicle, the run-time engine 208 may in turn send a signal to an operating system 210, such as a Linux Kernel 212, running on the system-on-a-chip (SOC) 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network (DNN) may be configured to run on a combination of processing blocks, such as the CPU 222 and the GPU 226, or may be run on the NPU 228, if present.

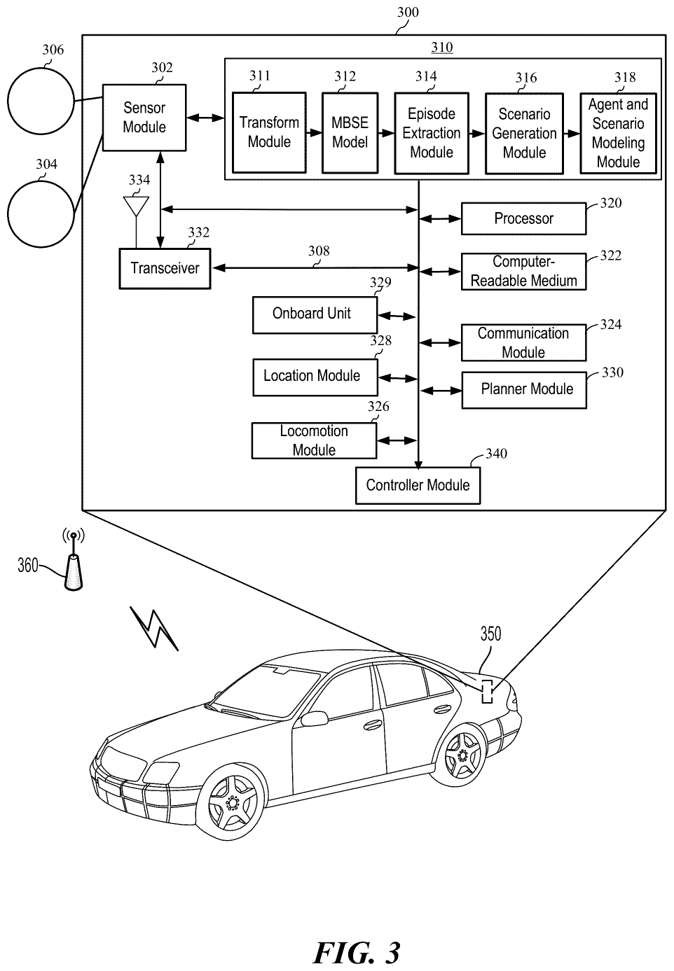

FIG. 3 is a diagram illustrating an example of a hardware implementation for an agent and scenario modeling system, according to aspects of the present disclosure. An agent and scenario modeling system 300 may be configured for application of a model-based systems engineering (MBSE) approach to detect and extract episodes of interest from large datasets for agent and scenario modeling. The agent and scenario modeling system 300 may generate a driving scenario of interest based on an episode of interest extracted from a dataset of interest according to an MBSE flowchart. The agent and scenario modeling system 300 may parameterize agent and/or scenario models used for autonomous operation of an ego vehicle (e.g., a car 350) using the generated driving scenario of interest.

The agent and scenario modeling system 300 may be a component of a vehicle, a robotic device, or other device. For example, as shown in FIG. 3, the agent and scenario modeling system 300 is a component of the car 350. Aspects of the present disclosure are not limited to the agent and scenario modeling system 300 being a component of the car 350, as other devices, such as a bus, motorcycle, or other like vehicle, are also contemplated for using the agent and scenario modeling system 300. The car 350 may be autonomous or semi-autonomous.

The agent and scenario modeling system 300 may be implemented with an interconnected architecture, represented generally by an interconnect 308. The interconnect 308 may include any number of point-to-point interconnects, buses, and/or bridges depending on the specific application of the agent and scenario modeling system 300 and the overall design constraints of the car 350. The interconnect 308 links together various circuits, including one or more processors and/or hardware modules, represented by a sensor module 302, a vehicle training and model verification module 310, a processor 320, a computer-readable medium 322, a communication module 324, a locomotion module 326, a location module 328, an onboard unit 329, a planner module 330, and a controller module 340. The interconnect 308 may also link various other circuits, such as timing sources, peripherals, voltage regulators, and power management circuits, which are well known in the art, and therefore, will not be described any further.

The agent and scenario modeling system 300 includes a transceiver 332 coupled to the sensor module 302, the vehicle training and model verification module 310, the processor 320, the computer-readable medium 322, the communication module 324, the locomotion module 326, the location module 328, the onboard unit 329, the planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the car 350. As another example, the transceiver 332 may transmit a generated scenario and/or planned actions from the vehicle training and model verification module 310 to a server (not shown).

The agent and scenario modeling system 300 includes the processor 320 coupled to the computer-readable medium 322. The processor 320 performs processing, including the execution of software stored on the computer-readable medium 322 to provide agent and scenario modeling functionality, according to the present disclosure. The software, when executed by the processor 320, causes the agent and scenario modeling system 300 to perform the various functions described for ego vehicle operation in response to perception of objects of interest for an ego vehicle within video captured by a single camera of an ego vehicle, such as the car 350, or any of the modules (e.g., 302, 310, 324, 326, 328, 330, and/or 340). The computer-readable medium 322 may also be used for storing data that is manipulated by the processor 320 when executing the software.

The sensor module 302 may obtain images via different sensors, such as a first sensor 304 and a second sensor 306. The first sensor 304 may be a vision sensor (e.g., a stereoscopic camera or a red-green-blue (RGB) camera) for capturing two-dimensional (2D) RGB images. The second sensor 306 may be a ranging sensor, such as a light detection and ranging (LIDAR) sensor or a radio detection and ranging (RADAR) sensor. Of course, aspects of the present disclosure are not limited to the aforementioned sensors, as other types of sensors (e.g., thermal, sonar, and/or lasers) are also contemplated for either of the first sensor 304 or the second sensor 306.

The images of the first sensor 304 and/or the second sensor 306 may be processed by the processor 320, the sensor module 302, the vehicle training and model verification module 310, the communication module 324, the locomotion module 326, the location module 328, and the controller module 340. In conjunction with the computer-readable medium 322, the images from the first sensor 304 and/or the second sensor 306 are processed to implement the functionality described herein. In one configuration, feature information determined from images captured by the first sensor 304 and/or the second sensor 306 may be transmitted via the transceiver 332. The first sensor 304 and the second sensor 306 may be coupled to the car 350 or may be in communication with the car 350.

Safety is a critical concern when building autonomous agents (e.g., the car 350) that operate in human environments. For autonomous driving in particular, safety is a formidable challenge due to high speeds, rich environments, and complex dynamic interactions with many traffic participants, including vulnerable road users. Testing and verification of machine learning techniques for vehicle control by selecting an appropriate vehicle control action of an ego vehicle are desired. For example, autonomous test vehicles as well as test vehicles operated by expert drivers generate a log of data during real-world driving scenarios. These vehicles generate large datasets regarding various different driving scenarios. Unfortunately, because of the size and difficulty of parsing through these large datasets, the detection and extraction of episodes of interest can be difficult and time-consuming.

Some aspects of the present disclosure are directed to application of a model-based systems engineering (MBSE) approach to detect and extract episodes of interest from large datasets. In some aspects of the present disclosure, this MBSE approach breaks down each driving situation into a flowchart that describes a vehicle's behavior in a particular scenario. In an example, a flowchart (e.g., generated via an MBSE approach) in conjunction with a statistical or machine learning model is used to identify datasets of interest (e.g., from amongst a large dataset). For example, in a scenario involving a lane change, the flowchart includes decision trees such as “is the lane next to me vacant/not vacant.” The decision tree continues down each branch related to a lane change. In another example, the MBSE flowchart in conjunction with the machine learning model are used to identify other datasets of interest. Such datasets may then be used to parameterize agent and/or scenario models used for autonomous operation of an ego vehicle, such as the car 350.

Connected vehicle applications support vehicle-to-vehicle (V2V) communications and vehicle-to-infrastructure (V2I) communications with wireless technology. For example V2V communications use wireless signals to send information back and forth between other connected vehicles (e.g., location, speed, and/or direction). Conversely, V2I communications involve V2I (e.g., road signs or traffic signals) communications, generally involving vehicle safety issues. For example, V2I communications may request traffic information from a traffic management system to determine best possible routes. V2V and V2I applications for connected vehicles dramatically increase automotive safety by transforming vehicle operation.

The location module 328 may determine a location of the car 350. For example, the location module 328 may use a global positioning system (GPS) to determine the location of the car 350. The location module 328 may implement a dedicated short-range communication (DSRC)-compliant GPS unit. A DSRC-compliant GPS unit includes hardware and software to make the car 350 and/or the location module 328 compliant with one or more of the following DSRC standards, including any derivative or fork thereof: EN 12253:2004 Dedicated Short-Range Communication—Physical layer using microwave at 5.9 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

A dedicated short-range communication (DSRC)-compliant global positioning system (GPS) unit within the location module 328 is operable to provide GPS data describing the location of the car 350 with space-level accuracy for accurately directing the car 350 to a desired location. For example, the car 350 is driving to a predetermined location and desires partial sensor data. Space-level accuracy means the location of the car 350 is described by the GPS data sufficient to confirm a location of the parking space of the car 350. That is, the location of the car 350 is accurately determined with space-level accuracy based on the GPS data from the car 350.

The communication module 324 may facilitate communications via the transceiver 332. For example, the communication module 324 may be configured to provide communication capabilities via different wireless protocols, such as Wi-Fi, long term evolution (LTE), third generation (3G), etc. The communication module 324 may also communicate with other components of the car 350 that are not modules of the agent and scenario modeling system 300. The transceiver 332 may be a communications channel through a network access point 360. The communications channel may include dedicated short-range communication (DSRC), LTE, LTE-device-to-device (D2D) (LTE-D2D), mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, dedicated short-range communication (DSRC), full-duplex wireless communications, mmWave, Wi-Fi (infrastructure mode), Wi-Fi (ad-hoc mode), visible light communication, TV white space communication, and satellite communication. The network access point 360 may also include a mobile data network that may include third generation (3G), fourth generation (4G), fifth generation (5G), long term evolution (LTE), LTE-vehicle-to-everything (V2X) (LTE-V2X), LTE-device-to-device (D2D) (LTE-D2D), voice over long term evolution (VoLTE), or any other mobile data network or combination of mobile data networks. Further, the network access point 360 may include one or more Institute of Electrical and Electronics Engineers (IEEE) 802.11 wireless networks.

The agent and scenario modeling system 300 also includes the planner module 330 for planning a selected trajectory to perform a route/action (e.g., collision avoidance) of the car 350, and the controller module 340 to control the locomotion of the car 350. The controller module 340 may perform the selected action via the locomotion module 326 for autonomous operation of the car 350 along, for example, a selected route. In one configuration, the planner module 330 and the controller module 340 may collectively override a user input when the user input is expected (e.g., predicted) to cause a collision according to an autonomous level of the car 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous vehicles (e.g., Level 0, Level 1, Level 2, Level 3, Level 4, and Level 5). For example, if an autonomous vehicle has a higher level number than another autonomous vehicle (e.g., Level 3 is a higher level number than Levels 2 or 1), then the autonomous vehicle with a higher level number offers a greater combination and quantity of autonomous features relative to the vehicle with the lower level number. These different levels of autonomous vehicles are described briefly below.

Level 0: In a Level 0 vehicle, the set of advanced driver assistance system (ADAS) features installed in a vehicle provide no vehicle control, but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (ACC); parking assistance with automated steering; and lane keeping assistance (LKA) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks, but must still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the jurisdiction where the vehicle is located).

A highly autonomous vehicle (HAV) is an autonomous vehicle that is Level 3 or higher. Accordingly, in some configurations the car 350 is one of the following: a Level 0 non-autonomous vehicle; a Level 1 autonomous vehicle; a Level 2 autonomous vehicle; a Level 3 autonomous vehicle; a Level 4 autonomous vehicle; a Level 5 autonomous vehicle; and highly autonomous vehicle.

The vehicle training and model verification module 310 may be in communication with the sensor module 302, the processor 320, the computer-readable medium 322, the communication module 324, the locomotion module 326, the location module 328, the onboard unit 329, the planner module 330, the transceiver 332, and the controller module 340. In one configuration, the vehicle training and model verification module 310 receives sensor data from the sensor module 302. The sensor module 302 may receive the sensor data from the first sensor 304 and the second sensor 306. According to aspects of the present disclosure, the vehicle training and model verification module 310 may receive sensor data directly from the first sensor 304 or the second sensor 306. In this aspect of the present disclosure, the vehicle training and model verification module 310 parameterizes agent and/or scenario models used for autonomous operation of the car 350 using a generated driving scenario of interest.

As shown in FIG. 3, the vehicle training and model verification module 310 includes a transform module 311, a model-based systems engineering (MBSE) model 312, an episode extraction module 314, a scenario generation module 316, and an agent and scenario modeling module 318. The transform module 311, the MBSE model 312, the episode extraction module 314, the scenario generation module 316, and the agent and scenario modeling module 318 may be components of a same or different artificial neural network, such as a convolutional neural network (CNN). The components of the training and model verification module 310 are not limited to a CNN. In operation, the training and model verification module 310 receives a data stream from the first sensor 304 and/or the second sensor 306. The data stream may include a two-dimensional red-green-blue (2D RGB) image from the first sensor 304 and light detection and ranging (LIDAR) data points from the second sensor 306. The data stream may include multiple frames, such as image frames. In this configuration, the first sensor 304 captures monocular (single camera) 2D RGB images.

The training and model verification module 310 is configured to parameterize agent and/or scenario models used for autonomous operation of the car 350 using a generated driving scenario of interest. Aspects of the present disclosure are directed to application of a model-based systems engineering (MBSE) approach to detect and extract episodes of interest from large datasets for agent and scenario modeling. In this example, the transform module 311 is configured to transform sensor data received from the sensor module 302 into high level events. For example, the transform module 311 is configured to convert sensor information indicating where detected objects are into information high level events, such as, ‘object x has started changing lanes.’ In addition, the transform module 311 may be configured to combine road information and positional information to determine an estimated deviation from a centerline of a lane occupied by the car 350 as a high level event.

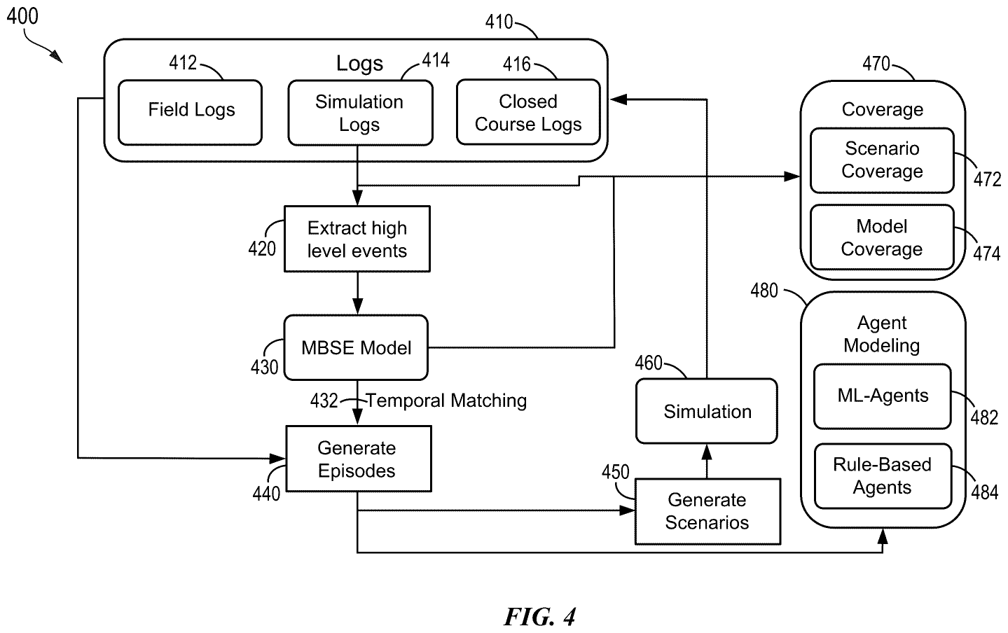

The MBSE model 312 is configured to analyze high-level events extracted from driving log data to identify a dataset of interest from the driving log data. The episode extraction module 314 is configured to generate a driving scenario of interest based on an episode of interest extracted from the dataset of interest according to an MBSE flowchart. The scenario generation module 316 is configured to generate a driving scenario of interest based on the episode of interest. The agent and scenario modeling module 318 is configured to parameterize agent and/or scenario models used for autonomous operation of an ego vehicle (e.g., a car 350) using the generated driving scenario of interest, for example, as shown in FIG. 4.

FIG. 4 is a block diagram of a vehicle training and model verification system 400 for the agent and scenario modeling system 300 of FIG. 3, in accordance with an illustrative configuration of the present disclosure. As shown in FIG. 4, the vehicle training and model verification system 400 includes telemetry logs 410, which may be generated by autonomous test vehicles as well as test vehicles operated by expert drivers during real-world driving scenarios. In the example of FIG. 4, the telemetry logs 410 include field logs 412, simulation logs 414, and closed course logs 416. At block 420, high-level events are extracted from driving log data of the telemetry logs 410 generated during test vehicle operation. In some aspects of the present disclosure, the telemetry logs 410 are consumed to extract a sequence of events, which are provided to a model-based systems engineering (MBSE) model 430.

In aspects of the present disclosure, the MBSE model 430 processes the sequence of events using temporal matching 432 to identify and extract events of interest from the extracted sequence of events to generate episodes at the generate episodes block 440. As described, an episode refers to a fixed series of events that progress deterministically, and does not contain branches because an episode is a single branch within a scenario tree. For example, the generate episodes at the generate episodes block 440 may output an episode, such as “this is an aborted lane change,” or “this is an aggressive lane change,” or “this is an illegal lane change,” etc. In situations where a failure of the MBSE model 430 to capture an episode of interest is detected, the MBSE model 430 may be analyzed to add an additional model path to improve the MBSE model 430.

In some aspects of the present disclosure, episodes from the generate episodes block 440 are collected by the agent modeling block 480 for training machine learned (ML)-agents 482. In addition, episodes from the generate episodes block 440 are collected by the agent modeling block 480 for optimizing the rule-based agents 484. In these aspects of the present disclosure, the agent modeling block 480 trains the ML-agents 482 and derives rules for the rule-based agents 484, according to episodes of interest identified from the generate episodes block 440.

In some aspects of the present disclosure, scenarios are generated at a generate scenarios block 450. As described, a scenario may be derived from an episode by varying fixed properties of the episode. For example, a unit under test may be re-simulated using a simulation 460. Other possible variations include replacing pedestrian's tracks with a smart agent, adjusting the weather, or other like variation using the simulation 460. In some aspects of the present disclosure, particular types of scenarios are collected and analyzed to determine variational distributions for scenario modeling of driving features. These scenarios are formed using the generate scenarios block 450 by spinning episodes from the generate episodes block 440.

In some aspects of the present disclosure, a coverage block 470 is configured to identify gaps in coverage testing according to a scenario coverage block 472 and a model coverage block 474. For example, the coverage block 470 determines gaps in coverage testing according to identified scenarios of interest, which are used to refine the scenario coverage block 472. In addition, the coverage block 470 may refine the model coverage block 474 based on the identified scenarios of interest. The coverage block 470 may establish bounds for evaluation of system requirements by defining distributions used in variational tests from the simulation 460 or sampling techniques from the MBSE model 430. In some aspects of the present disclosure, the coverage block 470 may execute logs generated from the simulation 460 to find coverage holes using the scenario coverage block 472 and the model coverage block 474.

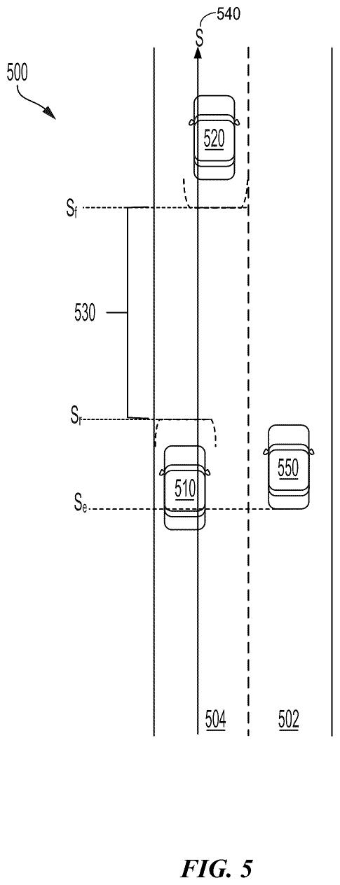

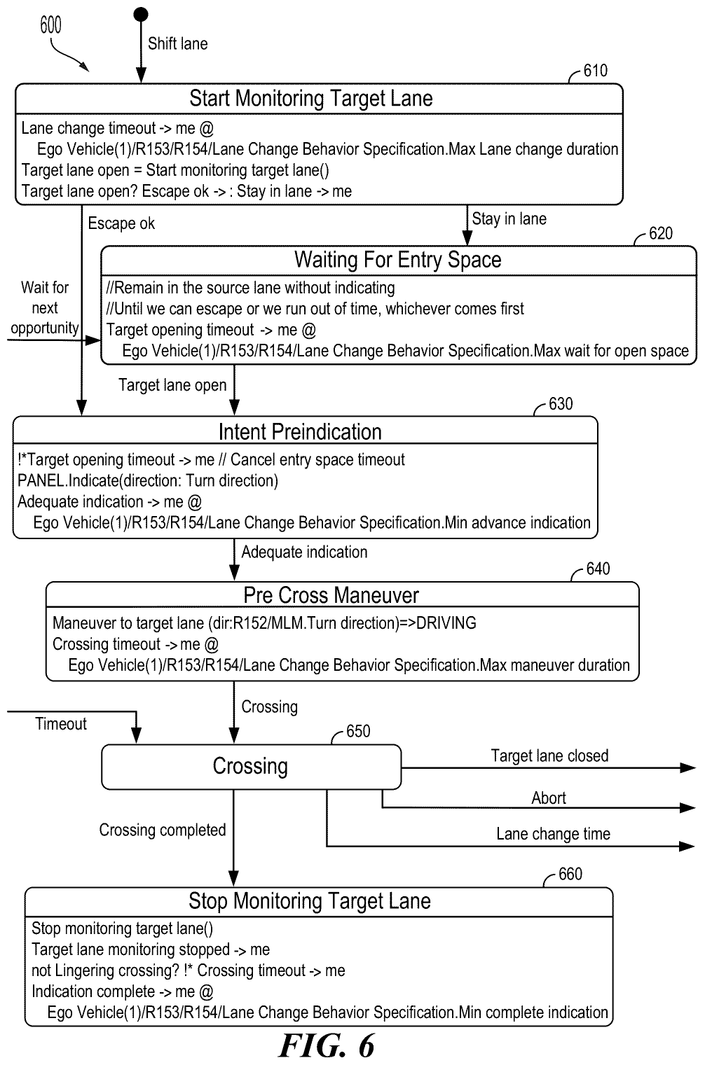

FIG. 5 is a diagram illustrating an overview of a traffic environment, including vehicles on highway lanes as well as an ego vehicle prior to a lane change, according to aspects of the present disclosure. Some aspects of the present disclosure are directed to application of a model-based systems engineering (MBSE) approach to detect and extract episodes of interest from large datasets, such as the lane change shown in FIG. 5. In some aspects of the present disclosure, this MBSE approach breaks down each driving situation into a flowchart that describes a vehicle's behavior in a particular scenario. FIG. 6 illustrates an MBSE state transition diagram 600 for defining a vehicle's behavior during a lane change, according to aspects of the present disclosure.

Referring again to FIG. 5, a traffic environment includes a multilane highway 500 (e.g., a two lane highway), having a first lane 502 and a target lane 504 (e.g., a second lane), in which the first lane 502 includes an ego vehicle 550. In this configuration, the ego vehicle 550 is configured to monitor the dynamics of vehicles on the multilane highway 500, such as a first vehicle 510 and a second vehicle 520 in the target lane 504 of the multilane highway 500. In this example, the ego vehicle 550 desires to changes lanes from the first lane 502 to the target lane 504 of the multilane highway 500. In this example, the ego vehicle 550, may be the car 350, shown in FIG. 3.

In one aspect of the present disclosure, the ego vehicle 550 is controlled by a vehicle controller (e.g., the controller module 340). In this example, the ego vehicle 550 identifies a merge gap 530 between the first vehicle 510 and the second vehicle 520 in the target lane 504. That is, the ego vehicle 550 is configured to identify the merge gap 530 to enable a lane change of the ego vehicle 550 from the first lane 502 to the target lane 504. According to aspects of the present disclosure, the ego vehicle 550 is configured to compute an exposure time in which the ego vehicle 550 is specified to merge into the merge gap 530.

As further illustrated in FIG. 5, an S-axis 540 indicates a position along the target lane 504 of the multilane highway 500. In this example, the ego vehicle 550 is shown at a position Sₑ. The position Sₑ can change with time “t,” so it becomes a function Sₑ(t). The same holds for the first vehicle 510 and the second vehicle 520 that define the merge gap 530. The first vehicle 510 (e.g., rear obstacle) has position Sᵣ(t), and the second vehicle 520 (e.g., front obstacle) has position S_{f}(t). The positions Sᵣ and S_{f} can be chosen to incorporate a predetermined amount of padding distance to account for the safe driving distance and the length of the ego vehicle 550. In some aspects of the present disclosure, the ego vehicle 550 performs the lane change based on the MBSE state transition diagram 600 of FIG. 6.

As shown in FIG. 6, at block 610, the ego vehicle 550 starts monitoring the target lane. As described with reference to FIG. 5, the ego vehicle 550 is configured to compute an exposure time in which the ego vehicle 550 is specified to merge into the merge gap 530. As shown in FIG. 6, the ego vehicle 550 also identifies an escape from performing the lane change to the target lane 504 by remaining in the first lane 502. At block 620, the ego vehicle waits for an entry space into the target lane 504, which may involve a maximum wait time for the open space. At block 630, the target lane is open and the ego vehicle 550 performs an intent pre-indication to specify a turn signal to enter the target lane 504. At block 640, the ego vehicle 550 performs a pre-cross maneuver and begins crossing into the target lane 504. At block 650, the ego vehicle 550 continues crossing into the target lane 504. At this point, the target lane may close, the expose time may be exceeded, or other scenario, which causes the ego vehicle 550 to abort the lane change. At block 660, the lane change is complete and the ego vehicle 550 stops monitoring the target lane 504.

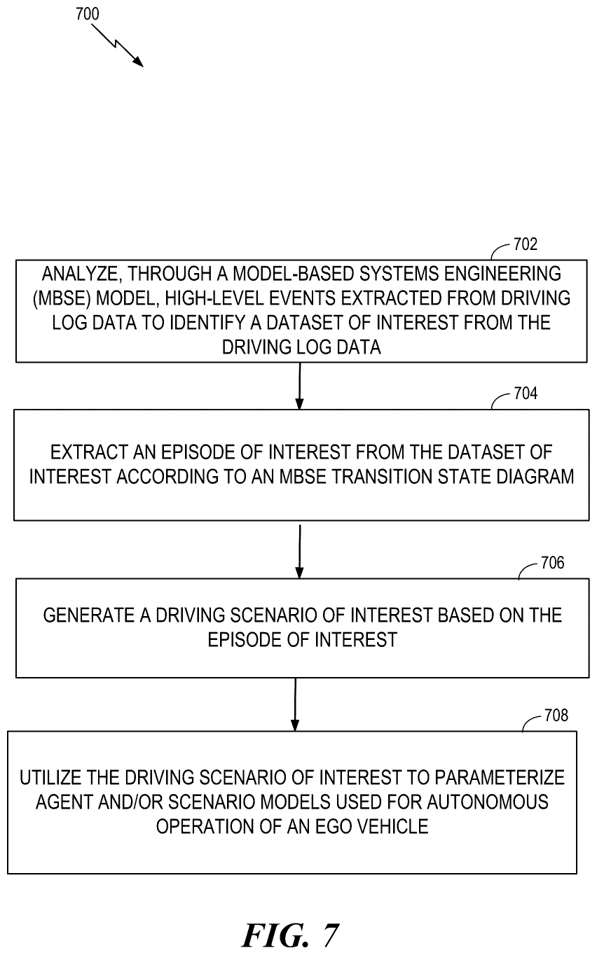

In some aspects of the present disclosure, the MBSE state transition diagram 600, in conjunction with a statistical or machine learning model (e.g., the MBSE model 430) is used to identify datasets of interest (e.g., from amongst a large dataset). In these aspects of the present disclosure, the MBSE state transition diagram 600 provides a model through which a flowchart of actions and conditions is generated. That is, a flowchart is derived from the MBSE state transition diagram 600. For example, in a scenario of FIG. 5 involving a lane change, the MBSE state transition diagram 600 includes transitions such as “is the lane next to me vacant/not vacant.” The decision tree continues down each branch related to a lane change. In another example, the MBSE state transition diagram 600 in conjunction with the machine learning model (e.g., the MBSE model 430) is used to identify other datasets of interest. Such datasets may then be used to parameterize agent and/or scenario models used for autonomous operation of an ego vehicle, such as the car 350, for example, as shown in FIG. 7.

FIG. 7 is a flowchart illustrating a method for agent and scenario modeling, according to aspects of the present disclosure. The method 700 begins at block 702, in which a model-based systems engineering (MBSE) model, analyzes high-level events extracted from driving log data to identify a dataset of interest from the driving log data. For example, as shown in FIG. 4, at block 420, high-level events are extracted from driving log data of the telemetry logs 410 generated during test vehicle operation. In some aspects of the present disclosure, the telemetry logs 410 are consumed to extract a dataset of interest, which may be composed of a sequence of events that are provided to the MBSE model 430.

At block 704, an episode of interest is extracted from the dataset of interest according to an MBSE state transition diagram. For example, as shown in FIG. 4, the MBSE model 430 processes the sequence of events from the dataset of interest using temporal matching 432 to identify and extract events of interest to generate episodes at the generate episodes block 440. As described, an episode refers to a fixed series of events that progress deterministically, and does not contain branches because an episode is a single branch within a scenario tree. For example, the generate episodes block 440 may output an episode, such as “this is an aborted lane change,” or “this is an aggressive lane change,” or “this is an illegal lane change,” etc.

At block 706, a driving scenario of interest is generated based on the episode of interest. For example, as shown in FIG. 4, scenarios are generated at a generate scenarios block 450. As described, a scenario may be derived from an episode by varying fixed properties of the episode. For example, a unit under test may be re-simulated using a simulation 460. Other possible variations include replacing pedestrian's tracks with a smart agent, adjusting the weather, or other like variation using the simulation 460. In some aspects of the present disclosure, particular types of scenarios are collected and analyzed to determine variational distributions for scenario modeling of driving features. These scenarios are formed using the generate scenarios block 450 by spinning episodes from the generate episodes block 440.

At block 708, the driving scenario of interest is used to parameterize agent and/or scenario models used for autonomous operation of an ego vehicle. For example, as shown in FIG. 4, a coverage block 470 is configured to identify gaps in coverage testing according to a scenario coverage block 472 and a model coverage block 474. For example, the coverage block 470 determines gaps in coverage testing according to identified scenarios of interest, which are used to refine the scenario coverage block 472. In addition, the coverage block 470 may refine the model coverage block 474 based on the identified scenarios of interest. The coverage block 470 may establish bounds for evaluation of system requirements by defining distributions used in variational tests from the simulation 460 or sampling techniques from the MBSE model 430. In some aspects of the present disclosure, the coverage block 470 may execute logs generated from the simulation 460 to find coverage holes using the scenario coverage block 472 and the model coverage block 474.

The method 700 may include extracting an episode of interest by parsing field logs, simulation logs, and/or closed course logs to identify the dataset of interest, including corresponding sequences of events. The method 700 may include analyzing high-level event by generating the MBSE flowchart defining a behavior of a predetermined driving situation. The method 700 may also include analyzing high-level event by detecting the episode of interest from the dataset of interest according to the MBSE flowchart. The method 700 may further include modeling the scenario of interest according to the MBSE flowchart. The method 700 may also include utilizing the driving scenario of interest by generating a plurality of different driving scenarios of interest based on the episode of interest. The method 700 may further include utilizing the driving scenario of interest by training a machine learning model according to the plurality of different driving scenarios of interest.

The method 700 may also include training the machine learning agent model according to the plurality of different driving scenarios of interest. The method 700 may further include training rule-based agents according to the plurality of different driving scenarios of interest. The method 700 may further include utilizing the driving scenario of interest by generating a plurality of different driving scenarios of interest based on the episode of interest, and verifying coverage of a machine learning model according to the plurality of different driving scenarios of interest. The method 700 may also include utilizing the driving scenario of interest by generating a plurality of different driving scenarios of interest based on the episode of interest, and generating a simulation for an autonomous vehicle according to the plurality of different driving scenarios of interest. The method 700 may further include extracting high-level events from the driving log data generated during test vehicle operation, for example, as shown in FIG. 4.

In some aspects of the present disclosure, the method 700 may be performed by the system-on-a-chip (SOC) 100 (FIG. 1) or the software architecture 200 (FIG. 2) of the ego vehicle 150 (FIG. 1). That is, each of the elements of method 700 may, for example, but without limitation, be performed by the SOC 100, the software architecture 200, or the processor (e.g., CPU 102) and/or other components included therein of the ego vehicle 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application-specific integrated circuit (ASIC), a field-programmable gate array (FPGA) signal or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a compact disc-read-only memory (CD-ROM), and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, digital signal processors (DSPs), and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application-specific integrated circuit (ASIC) with the processor, the bus interface, the user interface, supporting circuitry, and at least a portion of the machine-readable media integrated into a single chip, or with one or more programmable gate arrays (PGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into random access memory (RAM) from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise random access memory (RAM), read-only memory (ROM), electrically erasable programmable read-only memory (EEPROM), compact disc-read-only memory (CD-ROM) or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., random access memory (RAM), read-only memory (ROM), a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for agent and scenario modeling, comprising:
analyzing, through a model-based systems engineering (MBSE) model, high-level events extracted from driving log data to identify a dataset of interest from the driving log data;
extracting an episode of interest from the dataset of interest according to an MBSE state transition diagram;
generating a driving scenario of interest based on the episode of interest; and
utilizing the driving scenario of interest to parameterize agent and/or scenario models used for autonomous operation of an ego vehicle.

2. The method of claim 1, in which extracting comprises parsing field logs, simulation logs, and/or closed course logs to identify the dataset of interest, including corresponding sequences of events.

3. The method of claim 1, in which analyzing comprises:
generating an MBSE flowchart defining a behavior of a predetermined driving situation using the MBSE state transition diagram;
detecting the episode of interest from the dataset of interest according to the MBSE generated flowchart; and
modeling the scenario of interest according to the MBSE generated flowchart.

4. The method of claim 1, in which utilizing the driving scenario of interest comprises:
generating a plurality of different driving scenarios of interest based on the episode of interest; and
training a machine learning model according to the plurality of different driving scenarios of interest.

5. The method of claim 4, in which training comprises training the machine learning agent model according to the plurality of different driving scenarios of interest.

6. The method of claim 4, in which training comprises training rule-based agents according to the plurality of different driving scenarios of interest.

7. The method of claim 1, in which utilizing the driving scenario of interest comprises:
generating a plurality of different driving scenarios of interest based on the episode of interest; and
verifying coverage of a machine learning model according to the plurality of different driving scenarios of interest.

8. The method of claim 1, in which utilizing the driving scenario of interest comprises:
generating a plurality of different driving scenarios of interest based on the episode of interest; and
generating a simulation for an autonomous vehicle according to the plurality of different driving scenarios of interest.

9. A non-transitory computer-readable medium having program code recorded thereon for agent and scenario modeling, the program code being executed by a processor and comprising:
program code to analyze, through a model-based systems engineering (MBSE) model, high-level events extracted from driving log data to identify a dataset of interest from the driving log data;
program code to extract an episode of interest from the dataset of interest according to an MBSE state transition diagraph;
program code to generate a driving scenario of interest based on the episode of interest; and
program code to utilize the driving scenario of interest to parameterize agent and/or scenario models used for autonomous operation of an ego vehicle.

10. The non-transitory computer-readable medium of claim 9, in which the program code to extract comprises program code to parse field logs, simulation logs, and/or closed course logs to identify the dataset of interest, including corresponding sequences of events.

11. The non-transitory computer-readable medium of claim 9, in which the program code to analyze comprises:
program code to generate an MBSE flowchart defining a behavior of a predetermined driving situation using the MBSE state transition diagram;
program code to detect the episode of interest from the dataset of interest according to the MBSE generated flowchart; and
program code to model the scenario of interest according to the MBSE generated flowchart.

12. The non-transitory computer-readable medium of claim 9, in which the program code to utilize the driving scenario of interest comprises:
program code to generate a plurality of different driving scenarios of interest based on the episode of interest; and
program code to train a machine learning model according to the plurality of different driving scenarios of interest.

13. The non-transitory computer-readable medium of claim 12, in which the program code to train comprises program code to train the machine learning agent model according to the plurality of different driving scenarios of interest.

14. The non-transitory computer-readable medium of claim 12, in which the program code to train comprises program code to train rule-based agents according to the plurality of different driving scenarios of interest.

15. The non-transitory computer-readable medium of claim 9, in which the program code to utilize the driving scenario of interest comprises:
program code to generate a plurality of different driving scenarios of interest based on the episode of interest; and
program code to verify coverage of a machine learning model according to the plurality of different driving scenarios of interest.

16. The non-transitory computer-readable medium of claim 9, in which the program code to utilize the driving scenario of interest comprises:
program code to generate a plurality of different driving scenarios of interest based on the episode of interest; and
program code to generate a simulation for an autonomous vehicle according to the plurality of different driving scenarios of interest.

17. A system for agent and scenario modeling, the system comprising:
a model-based systems engineering (MBSE) model to analyze high-level events extracted from driving log data to identify a dataset of interest from the driving log data;
an episode extraction module to extract an episode of interest from the dataset of interest according to an MBSE state transition diagraph;
a scenario generation module to generate a driving scenario of interest based on the episode of interest; and
an agent and scenario modeling to utilize the driving scenario of interest to parameterize agent and/or scenario models used for autonomous operation of an ego vehicle.

18. The system of claim 17, further comprising a transform module to transform sensor data and the driving log data into high-level events.

19. The system of claim 17, in which the episode extraction module is further to parse field logs, simulation logs, and/or closed course logs to identify the dataset of interest, including corresponding sequences of events.

20. The system of claim 17, in which the agent and scenario modeling is further to generate a plurality of different driving scenarios of interest based on the episode of interest, to verify coverage of a machine learning model according to the plurality of different driving scenarios of interest, and to generate a simulation for an autonomous vehicle according to the plurality of different driving scenarios of interest.
